(19) United States
(12) Patent Application Publication
(10) Pub. No.: US 2017/0269583 A1
(43) Pub. Date: Sep. 21, 2017

(54) HYBRID SYSTEM OF VIRTUAL WALLS AND LIGHTHOUSES FOR SELF-PROPELLED APPARATUSES

(71) Applicant: Lumiplus Technology (Suzhou) Co., Ltd., Taicang City (CN)

(72) Inventor: SHUN-YI CHEN, Taipei City (TW)

(21) Appl. No.: 15/135,226

(22) Filed: Apr. 21, 2016

(30) Foreign Application Priority Data
Mar. 15, 2016 (TW) 105203536

(51) Int. Cl. G05D 1/00; B60L 11/18; G05D 1/02

(52) U.S. Cl. CPC G05D 1/0011; G05D 1/0255; G05D 1/0259; B60L 11/1809

(57) ABSTRACT

A hybrid system of virtual walls and lighthouses for self-propelled apparatuses includes a self-propelled apparatus and a hybrid apparatus. The hybrid apparatus has a virtual-wall mode and a lighthouse mode. A first switch unit switches the hybrid apparatus to the virtual-wall mode or the lighthouse mode. The hybrid apparatus selectively being on one of a first detection mode, a second detection mode and a third detection mode emits first signals continuously. On the virtual-wall mode, after the self-propelled apparatus receives the first signal, the self-propelled apparatus walks away the block region of the hybrid apparatus. On the lighthouse mode, after the self-propelled apparatus receives the first signals, the self-propelled apparatus enters and then passes through the lighthouse region of the hybrid apparatus.

This application claims the benefit of Taiwan Patent Application Serial No. 105203536, filed Mar. 15, 2016, the subject matter of which is incorporated herein by reference.

### BACKGROUND OF INVENTION

1. Field of the Invention

The invention relates to a hybrid system of virtual walls and lighthouses for self-propelled apparatuses, and more particularly to the hybrid system of virtual walls and lighthouses for self-propelled apparatuses that is equipped with both infrared and supersonic devices.

2. Description of the Prior Art

In household cleaning, a self-propelled apparatus, named also as a robotic cleaner, is popular recently. The robotic cleaner can “walk” on the floor automatically, and clean the floor at the same time.

For the self-propelled apparatus to walk purposely, preset paths are assigned in advance, or preset images are provided in advance for later identification so as to determine thereby the forward direction, the speed and the travel distance. However, since the interior arrangement varies all the time, including objects inside and the corresponding locations occupied, thus, even in the same room, the self-propelled apparatus may encounter different environments from time to time. Thus, the aforesaid setting for the self-propelled apparatus to follow the same travelling path would be meaningless to meet practical needs.

Currently, to resolve the aforesaid environment-varying problem to some degrees, a concept of virtual walls is applied to define a pseudo wall to each prohibited area. When the self-propelled apparatus receives signals related to any of the virtual walls, it will walk back off or detour so as not to hit the virtual wall that defining the prohibited area.

However, to achieve the aforesaid operations, the virtual wall shall emit signals continuously, so that the receiver of the pass-by self-propelled apparatus can be sure to detect the signal and perform necessary back-off or detouring reaction. If a light-source emitter of the virtual wall is energized by a battery, then it shall be careful that the service life of the battery is limited. On the other hand, if the virtual wall applies a foreign source, then problems in unplugging carelessly and cabling on the floor may still remain.

In the art, a technique of teaching the self-propelled apparatus to emit a specific signal is developed. When the virtual wall receives this specific signal, the virtual wall would be triggered to issue another specific signal (a back-off signal for example) to the approaching self-propelled apparatus, such that the self-propelled apparatus can be prevented from entering the prohibited area. However, though such a technique may resolve the energy-consumption problem resulted from the virtual wall keeping emitting the specific signal. But if the self-propelled apparatus does not detect the back-off signal anyway, for example, then the self-propelled apparatus would still cross the virtual wall, enter the prohibited area, and even severely hit an object in the prohibited area. Thus, it is quite possible to damage the self-propelled apparatus.

### SUMMARY OF THE INVENTION

Accordingly, it is the primary object of the present invention to provide a hybrid system of virtual walls and lighthouses for self-propelled apparatuses that can reduce the possibility of the self-propelled apparatus failing to receive the signals.

In the present invention, the hybrid system of virtual walls and lighthouses for self-propelled apparatuses includes a self-propelled apparatus and a hybrid apparatus. The self-propelled apparatus includes a main body and a transmission module, in which the transmission module is located at the main body, and the transmission module is to emit an infrared signal. The hybrid apparatus includes a first switch unit and a detection unit, and has a virtual-wall mode and a lighthouse mode. The first switch unit is to switch the hybrid apparatus to one of the virtual-wall mode and the lighthouse mode. The detection unit includes a first detection mode, a second detection mode and a third detection mode. The hybrid apparatus is selectively on one of the first detection mode, the second detection mode and the third detection mode. When the hybrid apparatus is on the first detection mode and receives the infrared signal, the hybrid apparatus is to emit first signals continuously. When the hybrid apparatus is on the second detection mode, the hybrid apparatus uses a supersonic signal to detect a distance between the self-propelled apparatus and the hybrid apparatus. The hybrid apparatus is to emit the first signals continuously if the distance is smaller than a threshold value. When the hybrid apparatus is on the third detection mode, the hybrid apparatus is to emit the first signals continuously if the hybrid apparatus receives the infrared signal or the distance is smaller than the threshold value. When the hybrid apparatus is on the virtual-wall mode, a coverage region of the first signals is a block region, and the self-propelled apparatus walks away the block region of the corresponding hybrid apparatus after the self-propelled apparatus receives the first signals. When the hybrid apparatus is on the lighthouse mode, the coverage region of the first signals is a lighthouse region, and the self-propelled apparatus enters and then passes through the lighthouse region of the corresponding hybrid apparatus after the self-propelled apparatus receives the first signals.

In one embodiment of the present invention, after the self-propelled apparatus enters and then passes through the lighthouse region of the corresponding hybrid apparatus, and till the self-propelled apparatus leaves the lighthouse region of the corresponding hybrid apparatus, the first switch unit switches the hybrid apparatus to the virtual-wall mode.

In one embodiment of the present invention, the hybrid system of virtual walls and lighthouses for self-propelled apparatuses further includes a second switch unit. When the hybrid apparatus is on the lighthouse mode, the lighthouse mode has a preset reference time, a first time value and a second time value. The first time value is larger than the preset reference time, and the preset reference time is larger than the second time value. The second switch unit is to switch the self-propelled apparatus in the lighthouse region of the hybrid apparatus to work for one of the preset reference time, the first reference time and the second time value.

In one embodiment of the present invention, the hybrid apparatus includes a light-adjusting unit for adjusting strength of the first signal.

In one embodiment of the present invention, the self-propelled apparatus further includes a turning member located at the main body. When the receiving member of the self-propelled apparatus receives a block signal, the turning member has the main body to turn so as to walk away the block region of the hybrid apparatus.

In one embodiment of the present invention, the first signal is an infrared signal.

In one embodiment of the present invention, the hybrid system of virtual walls and lighthouses for self-propelled apparatuses further includes a recharging station. After the self-propelled apparatus leaves the lighthouse region of the hybrid apparatus, the self-propelled apparatus enters the recharging station, and then the self-propelled apparatus electrically couples the recharging station.

Accordingly, by providing the hybrid system of virtual walls and lighthouses for self-propelled apparatuses in accordance with the present invention, the hybrid apparatus can selectively determine one of the first detection mode, the second detection mode and the third detection mode to work. Thereby, upon either the hybrid apparatus to receive the infrared signal from the self-propelled apparatus or the supersonic detection module to detect that the distance is lower than the threshold value, the hybrid apparatus can emit the signals. In the case that the hybrid apparatus is on the virtual-wall mode, the self-propelled apparatus would walk away the block region of the hybrid apparatus. On the other hand, in the case that the hybrid apparatus is on the lighthouse mode, then the self-propelled apparatus would enter and pass through the lighthouse region of the corresponding hybrid apparatus.

Hence, in the case that the hybrid apparatus fails, due to any reason, to receive the infrared signal emitted by the self-propelled apparatus (for example, a flash ray such as a sunshine may cause the hybrid apparatus not to successfully receive the infrared signal. Then, at this time, the supersonic detection can be introduced to resolve the foregoing shortcomings. Thus, by applying the ultrasonic detection mode of the second mode, if the distance between the self-propelled apparatus and the hybrid apparatus is too small, then the hybrid apparatus can be still driven to emit the signals for defining the virtual walls, such that the self-propelled apparatus can turn properly so as to avoid hitting the block region of the corresponding hybrid apparatus.

All these objects are achieved by the hybrid system of virtual walls and lighthouses for self-propelled apparatuses described below.

### BRIEF DESCRIPTION OF THE DRAWINGS

The present invention will now be specified with reference to its preferred embodiment illustrated in the drawings, in which:

FIG. 1 is a schematic view of a preferred embodiment of the hybrid system of virtual walls and lighthouses for self-propelled apparatuses in accordance with the present invention;

FIG. 2 shows schematically an embodiment of internal elements of the hybrid system of virtual walls and lighthouses for self-propelled apparatuses of FIG. 1;

FIG. 3 shows another state of FIG. 1;

FIG. 4 shows schematically another embodiment of internal elements of the hybrid system of virtual walls and lighthouses for self-propelled apparatuses of FIG. 1;

FIG. 5 demonstrates schematically a first process of the hybrid system of virtual walls and lighthouses for self-propelled apparatuses at work;

FIG. 6 demonstrates schematically a second process of the hybrid system of virtual walls and lighthouses for self-propelled apparatuses at work;

FIG. 7 demonstrates schematically a third process of the hybrid system of virtual walls and lighthouses for self-propelled apparatuses at work;

FIG. 8 demonstrates schematically a fourth process of the hybrid system of virtual walls and lighthouses for self-propelled apparatuses at work; and

FIG. 9 demonstrates schematically a fifth process of the hybrid system of virtual walls and lighthouses for self-propelled apparatuses at work.

### DESCRIPTION OF THE PREFERRED EMBODIMENT

The invention disclosed herein is directed to a hybrid system of virtual walls and lighthouses for self-propelled apparatuses. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

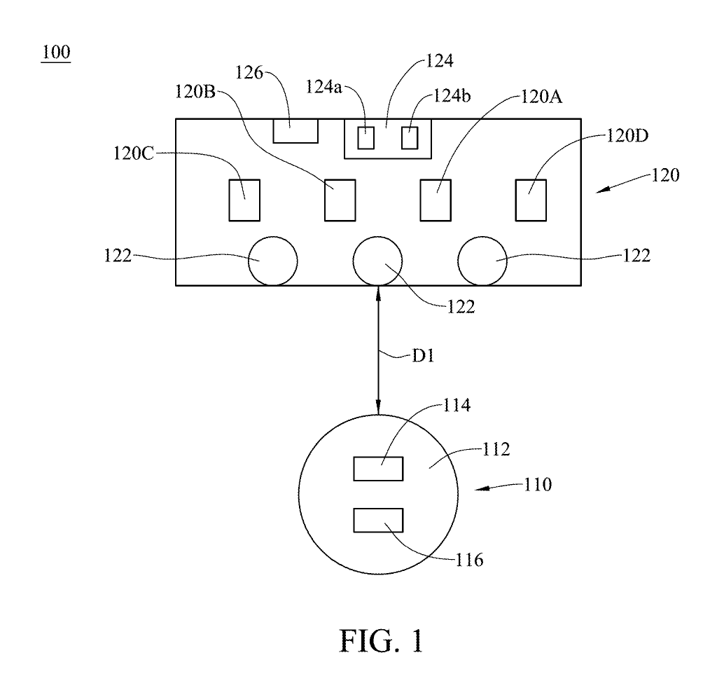

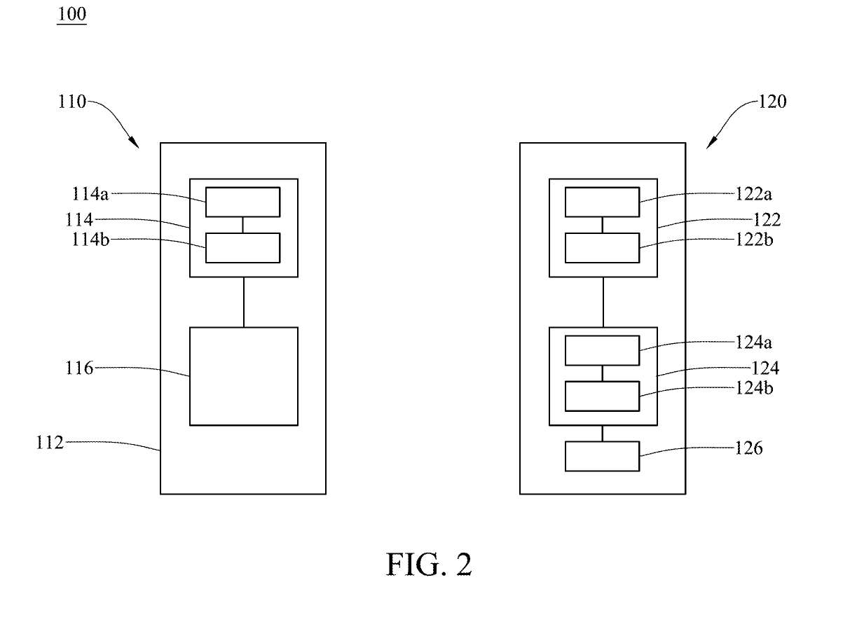

Refer now to FIG. 1 and FIG. 2; where FIG. 1 is a schematic view of a preferred embodiment of the hybrid system of virtual walls and lighthouses for self-propelled apparatuses in accordance with the present invention, and FIG. 2 shows schematically an embodiment of internal elements of the hybrid system of virtual walls and lighthouses for self-propelled apparatuses of FIG. 1.

As shown in FIG. 1, in this embodiment, the hybrid system of virtual walls and lighthouses for self-propelled apparatuses 100 includes a self-propelled apparatus 110 and a hybrid apparatus 120, in which the self-propelled apparatus 110 can be, but not limited to, a robotic cleaner. In other embodiment, the self-propelled apparatus 110 can be a self-propelled vehicle or ant the like.

The self-propelled apparatus 110 includes a main body 112, a transmission module 114 and a turning member 116. The transmission module 114 is located at the main body 112, the turning member 116 is also located at the main body 112, and the transmission module 114 is coupled with the turning member 114. The self-propelled apparatus can “walk” through relevant wheels (not shown in the figure), and the turning member 116 is applied to change the walk state of the self-propelled apparatus 110.

The hybrid apparatus 120 includes a plurality of infrared transmission modules 122 (three shown in this embodiment), a supersonic detection module 124 and an alert module 126, in which each of the infrared transmission modules 122 is coupled individually with the supersonic detection module 124, and the supersonic detection module 124 is further coupled with the alert module 126.

The infrared transmission module 122 is to receive signals from the self-propelled apparatus 110 or to transmit signals to the self-propelled apparatus 110. The supersonic detection module 124 is to detect a distance D1 between the self-propelled apparatus 110 and the hybrid apparatus 120.

Referring to FIG. 2, inside the main body 112 of the self-propelled apparatus 110, the transmission module 114 includes a emission member 114a and a receiving member 114b. In this embodiment, the transmission module 114 is an infrared transmission module. The emission member 114a of the self-propelled apparatus 110 is to transmit an infrared signal, and the receiving member 114b is to receive an infrared signal.

In the hybrid apparatus 120, the infrared transmission module 122 includes an infrared receiving member 122a and an infrared emission member 122b, in which the infrared receiving member 122a is electrically coupled with the infrared emission member 122b. The supersonic detection module 124 includes a supersonic emission member 124a and a supersonic receiving/calculating module 124b, in which the supersonic emission member 124a is electrically coupled with the supersonic receiving/calculating module 124b.

Referring now back to FIG. 1, the hybrid apparatus 120 has thereinside a first switch unit 120A, a detection unit 120B, a light-adjusting unit 120C and a second switch unit 120D, in which the detection unit 120B is coupled with the first switch unit 120A, the light-adjusting unit 120C and the second switch unit 120D.

The first switch unit 120A is to switch the hybrid apparatus 120 for choosing a virtual-wall mode or a lighthouse mode, so that the hybrid apparatus 120 can perform the virtual-wall mode or the lighthouse mode accordingly. The lighthouse mode has a preset reference time, a first time value and a second time value, in which the first time value is larger than the preset reference time, and the preset reference time is larger than the second time value. The second switch unit 120D is to switch the self-propelled apparatus 110 around the preset reference time, the first reference time and the second time value.

The detection unit 120B includes a first detection mode, a second detection mode and a third detection mode. The hybrid apparatus 120 selectively chooses one of the first detection mode, the second detection mode and the third detection mode to work. The light-adjusting unit 120C is to adjust the signal strength emitted by the hybrid apparatus 120.

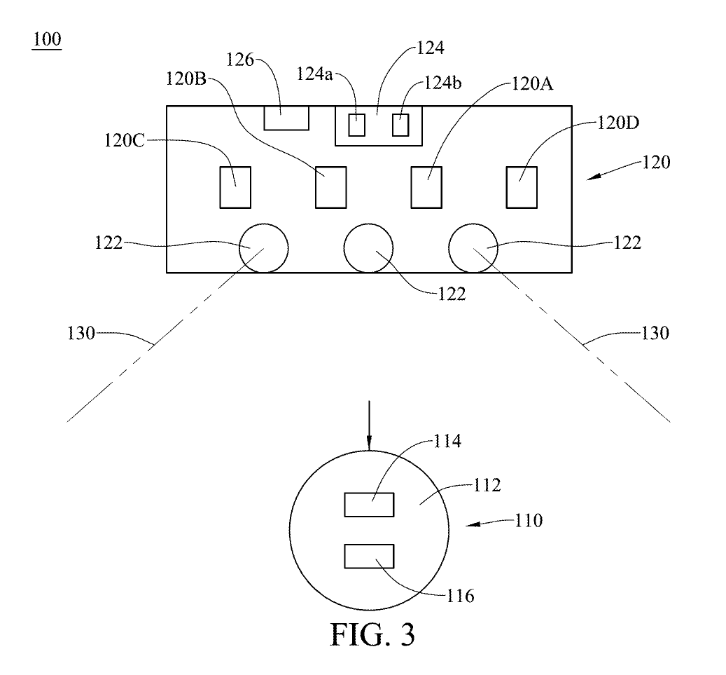

Refer now to FIG. 1 to FIG. 3, in which FIG. 3 shows another state of FIG. 1.

In the case that the detection unit 120B selects to perform the first detection mode, the infrared receiving member 122a of the hybrid apparatus 120 would receive the infrared signals emitted by the self-propelled apparatus 110. In the present invention, the infrared emission member 122b of the hybrid apparatus 120 is to emit first signals continuously, in which the first signal is particularly an infrared signal. The light-adjusting unit 120C is to adjust the strength of the first signal. In the case that the hybrid apparatus 120 is on the virtual-wall mode, the coverage region of the first signal is a block region 130. After the receiving member 114b of the self-propelled apparatus 110 receives the first signal, the self-propelled apparatus 110 would walk around or away the block region 130 of the hybrid apparatus 120. As shown in FIG. 3, by comparing to FIG. 1, the self-propelled apparatus 110 moves backward so as to avoid hitting the block region 1330 of the hybrid apparatus 120. In addition, since the infrared emission member 122b emits the infrared signals continuously for a period of time, thus the possibility of the receiving member 114b of the self-propelled apparatus 110 failing to receive the infrared signal is low.

In the case that the detection unit 120B chooses to perform the second detection mode, a supersonic signal is applied to detect or measure a distance D1 between the self-propelled apparatus 110 and the hybrid apparatus 120.

The supersonic emission member 124a is to provide the supersonic signal. As soon as the supersonic signal emitted by the supersonic emission member 124a is received by the self-propelled apparatus 110, the self-propelled apparatus 110 would respond to emit a reflective supersonic signal, and then the supersonic receiving/calculating module 124b would receive the reflective supersonic signal and thereby calculate the distance D1.

If the distance D1 detected by the supersonic detection module 124 is smaller than a threshold value, then the infrared emission member 122b of the hybrid apparatus 120 would emit the first signal. At this time, if the hybrid apparatus 120 is on the virtual-wall mode, then, after the receiving member 114b of the self-propelled apparatus 110 receives the first signal, the self-propelled apparatus 110 would walk away or around the block region 130 of the hybrid apparatus 120.

In the case that the detection unit 120B chooses to perform the third detection mode, and when the hybrid apparatus 120 receives the infrared signal or the distance D1 is less than the threshold value, the hybrid apparatus 120 would emit the first signal. At this time, if the hybrid apparatus 120 is on the virtual-wall mode, then, after the receiving member 114b of the self-propelled apparatus 110 receives the first signal, the self-propelled apparatus 110 would walk away or around the block region 130 of the hybrid apparatus 120.

Further, in this embodiment, if the self-propelled apparatus 110 does not walk near the hybrid apparatus 120 that is activated, the supersonic detection module 124 can be firstly applied to detect the distance D1. Under such a circumstance, if the supersonic detection module 124 determines that the distance D1 is lower than the threshold value, the alert module 126 will issue a warning (an indicator for example) to alert the user that this distance judgment by the supersonic detection module 124 is a fault signal. In another embodiment, while the hybrid apparatus 120 is activated, and if the infrared receiving member 122a of the hybrid apparatus 120 receives other signals or sunshine, not the infrared signal from the self-propelled apparatus 110, then the alert module 126 would issue a warning (an alarm light for example) to alert the user that a fault signal occurs. Upon such an arrangement, the situation of activating the infrared receiving member 122a of the hybrid apparatus 120 upon receiving an unnecessary signal can be avoided.

On the third detection mode of the present invention, if the distance D1 of the hybrid apparatus 120 is lower than the threshold value, it implies that the self-propelled apparatus 110 is pretty close to the hybrid apparatus 120. Then, even that the infrared receiving member 122a of the hybrid apparatus 120 does not receive the infrared signal emitted by the self-propelled apparatus 110, the infrared emission member 122b of the hybrid apparatus 120 can still be activated to emit the first signal. When the receiving member 114b of the self-propelled apparatus 110 receives the first signal, the turning member 116 would drive the main body 110 to turn so as to walk away from the block region 130 of the hybrid apparatus 120.

Furthermore, in one embodiment, while the self-propelled apparatus 110 walks too fast, the distance between the self-propelled apparatus 110 and the hybrid apparatus 120 would become larger. As the distance D1 changes too fast, then the infrared emission member 122b of the hybrid apparatus 120 would emit a block signal to prevent the self-propelled apparatus 110 from entering the block region 130 of the hybrid apparatus 120.

Under the aforesaid arrangement, the first switch unit 120A switches the hybrid apparatus 120 to the virtual-wall mode, and the hybrid apparatus 120 can selectively determine its own operations around the first detection mode, the second detection mode and the third detection mode.

When the first switch unit 120A switched the hybrid apparatus 120 to the lighthouse mode, the coverage region of the first signal is defined as a lighthouse region. After the receiving member 114b of the self-propelled apparatus 110 receives the first signal, then the self-propelled apparatus 110 would enter the lighthouse region of the hybrid apparatus 120.

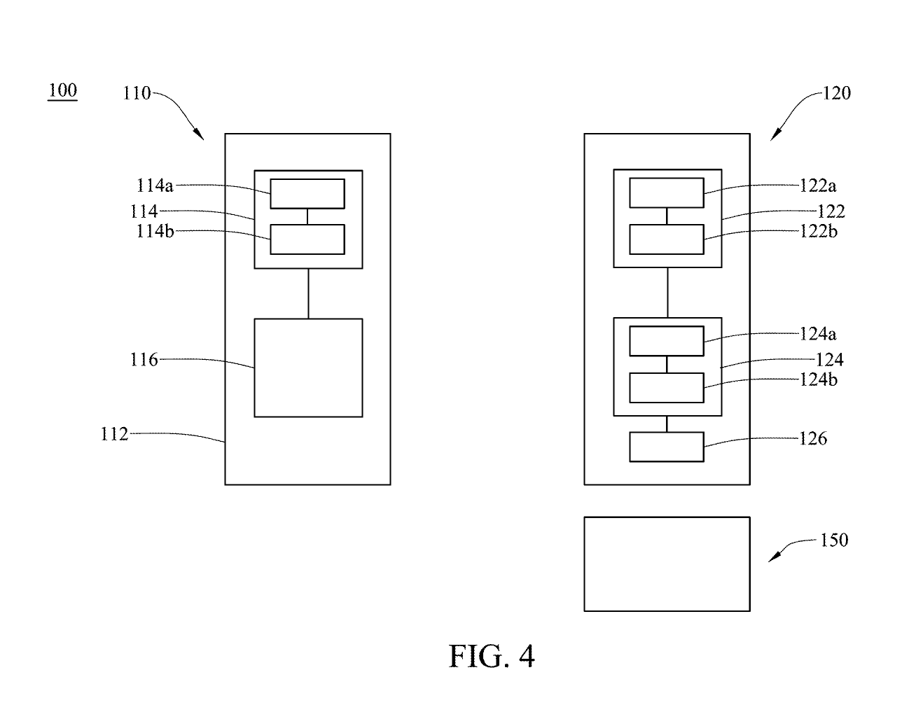

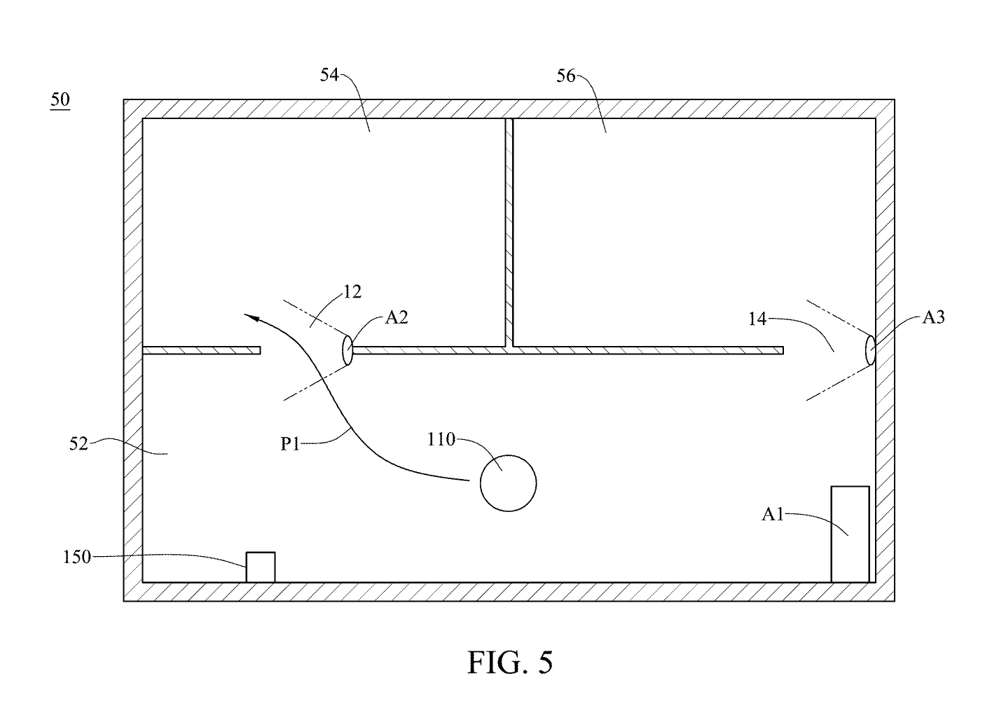

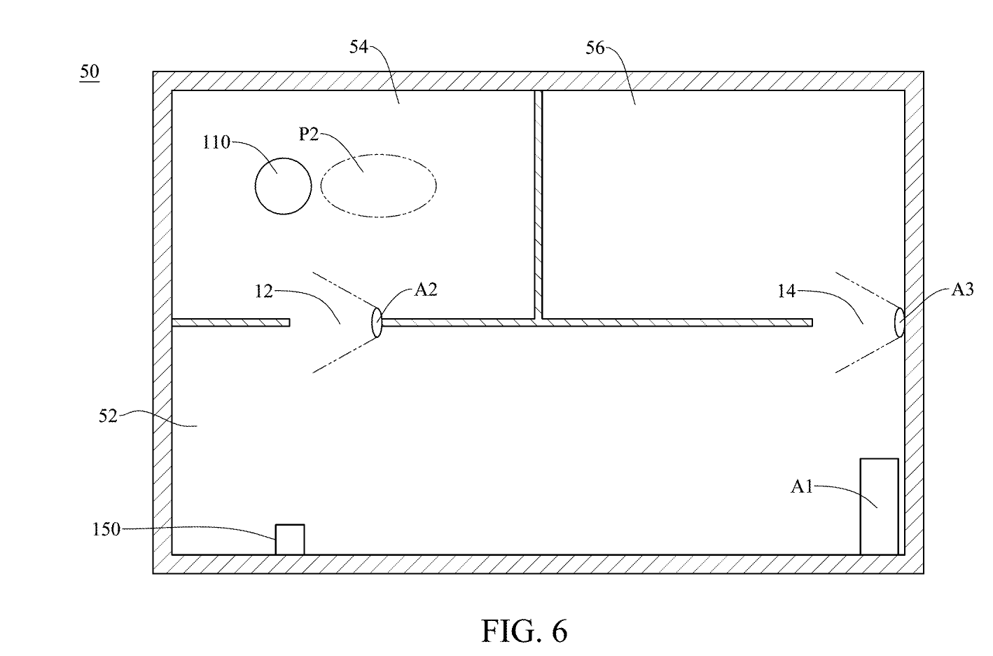

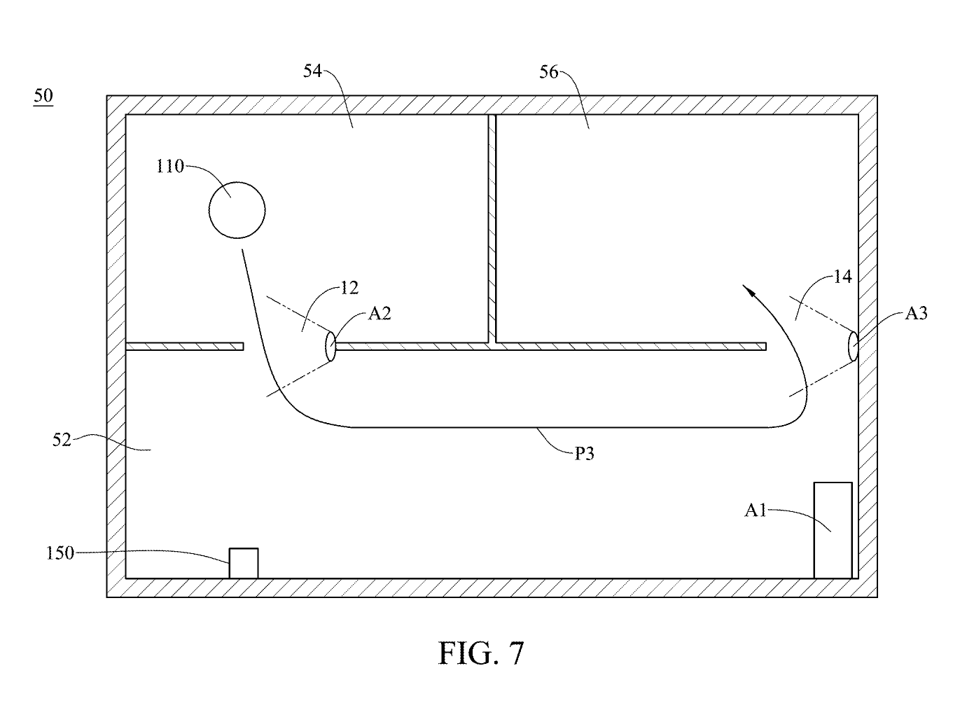

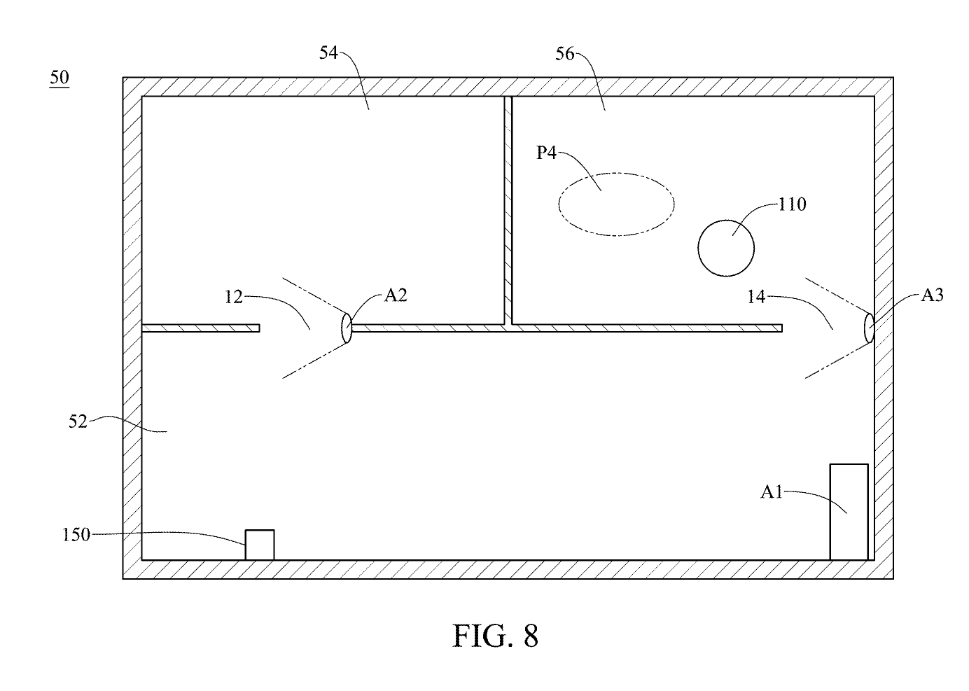

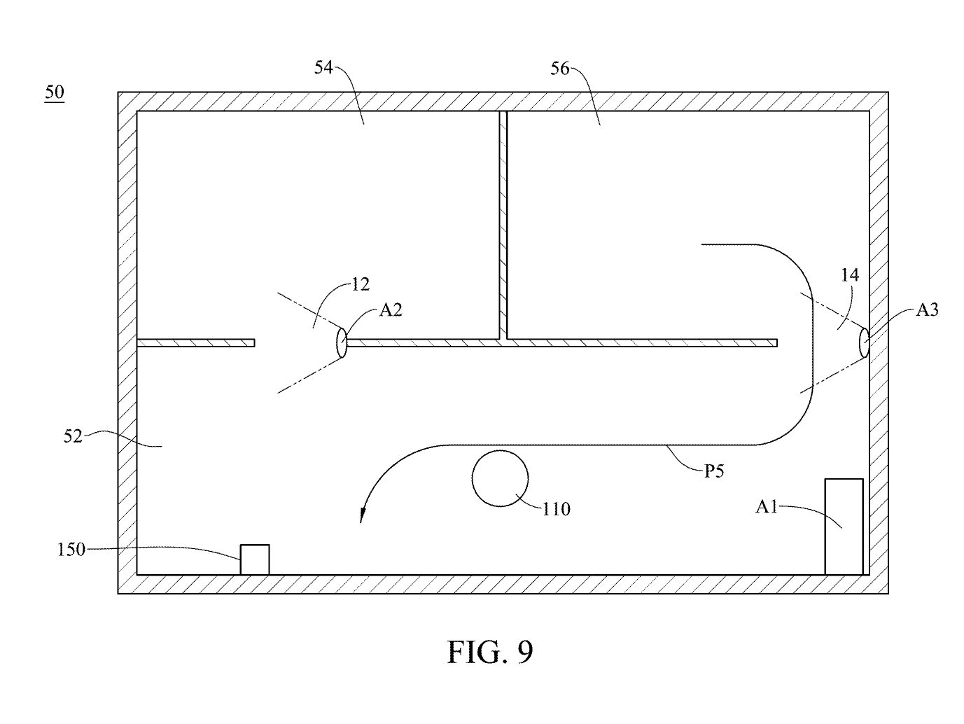

Refer now to FIG. 4 to FIG. 9; where FIG. 4 shows schematically another embodiment of internal elements of the hybrid system of virtual walls and lighthouses for self-propelled apparatuses of FIG. 1, FIG. 5 demonstrates schematically a first process of the hybrid system of virtual walls and lighthouses for self-propelled apparatuses at work, FIG. 6 demonstrates schematically a second process of the hybrid system of virtual walls and lighthouses for self-propelled apparatuses at work, FIG. 7 demonstrates schematically a third process of the hybrid system of virtual walls and lighthouses for self-propelled apparatuses at work, FIG. 8 demonstrates schematically a fourth process of the hybrid system of virtual walls and lighthouses for self-propelled apparatuses at work, and FIG. 9 demonstrates schematically a fifth process of the hybrid system of virtual walls and lighthouses for self-propelled apparatuses at work. In this embodiment, the hybrid system 100 of virtual walls and lighthouses for self-propelled apparatuses can further include a recharging station 150.

In FIG. 5 through FIG. 9, there are three rooms in each work area 50; a first room 52, a second room 54 and a third room 56. In one embodiment, there are also three hybrid apparatuses 120 (A1, A2 and A3). In addition, a single self-propelled apparatus 110 is located in the first room 52. The hybrid apparatus A1 located at a lateral side of the first room 52 is on the virtual-wall mode. The hybrid apparatus A2 located at a side of an entrance of the second room 54 is on the lighthouse mode. The hybrid apparatus A3 located at a side of an entrance of the third room 56 is also on the lighthouse mode. The operations of the self-propelled apparatus 110 and the three hybrid apparatuses A1, A2 and A3 of FIG. 4 to FIG. 9 are identical to those described in FIG. 1 to FIG. 3.

When the hybrid apparatus 120 is on the lighthouse mode (the hybrid apparatuses A2 and A3 for example), the infrared emission member 122b of the hybrid apparatus 120 would emit the first signals, and the coverage region of the first signals is defined as a lighthouse region. As the receiving member 114b of the self-propelled apparatus 110 receives the first signal, it implies that the self-propelled apparatus 110 is walking in the lighthouse region of the corresponding hybrid apparatus 120. Till the self-propelled apparatus 110 leaves the lighthouse region of the corresponding hybrid apparatus 120, the first switch unit 120A switches the hybrid apparatus 120 to the virtual-wall mode.

By having FIG. 5 as an example, the hybrid apparatus A1 is on the virtual-wall mode. The coverage region of the first signals of the hybrid apparatus A2 is shown to be a first lighthouse region 12, while the coverage region of the first signals of the hybrid apparatus A3 is shown to be a second lighthouse region 14.

If, for example, the self-propelled apparatus 110 is originally on the random walk mode, and as the receiving member 114b of the self-propelled apparatus 110 receives the first signals of the hybrid apparatus A1 that is on the virtual-wall mode, then the self-propelled apparatus 110 will walk away the hybrid apparatus A1. In another case, after the receiving member 114b of the self-propelled apparatus 110 receives the first signals of the hybrid apparatus A2, the self-propelled apparatus 110 would walk along a travelling path P1 to pass through the first lighthouse region of the hybrid apparatus A2 so as to enter the second room 54. In the second room 54, the self-propelled apparatus 110 can follow a travelling path P2 to perform the cleaning, as shown in FIG. 6. In this embodiment, the travelling path P1 of the self-propelled apparatus 110 can be a random, an along-the-wall, a Z-shape or a spiral pattern, and the second travelling path P2 of the self-propelled apparatus 110 can be a spiral pattern for cleaning the second room 54.

The second switch unit 120D (see FIG. 1) is to switch the self-propelled apparatus 110 for determining a period of working time period preferably selected from the group of the preset reference time, the first reference time and the second time value, generally representing a longer time period, a normal time period and a shorter time period, respectively. In this embodiment, the second switch unit 120D can switch the self-propelled apparatus 110 to work for the preset reference time, 15 minutes for example. After the self-propelled apparatus 110 stays in the second room 54 for cleaning for 15 minutes, the hybrid apparatus A2 would emit a first stop signal. Then, as the self-propelled apparatus 110 receives the first stop signal, the self-propelled apparatus 110 would walk through the first lighthouse region 12 generated by the hybrid apparatus A2 and leave the second room 54. Then, the first switch unit 120A switches the hybrid apparatus A2 to the virtual-wall mode so as to prevent the self-propelled apparatus 110 from re-entering the second room 54.

In other embodiment, if the second room 54 has a terrible situation for cleaning, namely requiring plenty of cleaning work, then the second switch unit 120D can switch the self-propelled apparatus 110 to work for the first time value which is larger than the preset reference time, 25 minutes for example. Thus, the self-propelled apparatus 110 can stay in the second room 54 for a longer time for completely cleaning the room. Of course, if the room's situation is minor, the user can determine the second switch unit 120D to switch the self-propelled apparatus 110 to work for the second time value which is smaller than the preset reference time, 10 minutes for example.

The self-propelled apparatus 110 can then resume the random walk mode. After the receiving member 114b of the self-propelled apparatus 110 receives the first signals from the hybrid apparatus A3 for example as shown in FIG. 7, the self-propelled apparatus 110 can walk along a travelling path P3 to pass through the second lighthouse region 14 of the hybrid apparatus A3 and thereby enter the third room 56. In the third room 56, the self-propelled apparatus 110 follows a travelling path P4 to perform the cleaning work inside the third room 56 as shown in FIG. 8. In this embodiment, the travelling path P3 of the self-propelled apparatus 110 can be a random, an along-the-wall, a Z-shape or a spiral pattern, and the travelling path P4 of the self-propelled apparatus 110 can be a spiral pattern for cleaning the third room 56.

After the self-propelled apparatus 110 stays in the third room 56 for cleaning for 15 minutes, the hybrid apparatus A3 would emit a second stop signal. Then, as the self-propelled apparatus 110 receives the second stop signal, the self-propelled apparatus 110 would walk through the second lighthouse region 14 generated by the hybrid apparatus A3 and leave the third room 56. Then, the first switch unit 120A switches the hybrid apparatus A3 to the virtual-wall mode so as to prevent the self-propelled apparatus 110 from re-entering the third room 56.

At this time, since the hybrid apparatus A2 and the hybrid apparatus A3 are both on the corresponding virtual-wall modes, so the self-propelled apparatus 110 would not re-enter the second room 54 or the third room 56. After the self-propelled apparatus 110 walks away from the hybrid apparatus A2 and the hybrid apparatus A3 as shown in FIG. 9, the self-propelled apparatus 110 would follow a travelling path P5 to enter a recharging station 150. In this embodiment, the travelling path P5 of the self-propelled apparatus 110 can be a random, an along-the-wall, a Z-shape or a spiral pattern.

A recharging member of the self-propelled apparatus 110 is electrically coupled with the recharging station 150, and the recharging station 150 can thus recharge the self-propelled apparatus 110.

In summary, by providing the virtual wall system for the self-propelled apparatus in accordance with the present invention, the hybrid apparatus can selectively determine one of the first detection mode, the second detection mode and the third detection mode to work. Thereby, upon either the hybrid apparatus to receive the infrared signal from the self-propelled apparatus or the supersonic detection module to detect that the distance is lower than the threshold value, the hybrid apparatus can emit the signals. In the case that the hybrid apparatus is on the virtual-wall mode, the self-propelled apparatus would walk away the block region of the hybrid apparatus. On the other hand, in the case that the hybrid apparatus is on the lighthouse mode, then the self-propelled apparatus would enter and pass through the lighthouse region of the corresponding hybrid apparatus.

Hence, in the case that the hybrid apparatus fails, due to any reason, to receive the infrared signal emitted by the self-propelled apparatus (for example, a flash ray such as a sunshine may cause the hybrid apparatus not to successfully receive the infrared signal. Then, at this time, the supersonic detection can be introduced to resolve the foregoing shortcomings. Thus, by applying the ultrasonic detection mode of the second mode, if the distance between the self-propelled apparatus and the hybrid apparatus is too small, then the hybrid apparatus can be still driven to emit the signals for defining the virtual walls, such that the self-propelled apparatus can turn properly so as to avoid hitting the block region of the corresponding hybrid apparatus.

While the present invention has been particularly shown and described with reference to a preferred embodiment, it will be understood by those skilled in the art that various changes in form and detail may be without departing from the spirit and scope of the present invention.

What is claimed is:

1. A hybrid system of virtual walls and lighthouses for self-propelled apparatuses, comprising:
a self-propelled apparatus, including a main body and a transmission module, the transmission module being located at the main body, the transmission module being to emit an infrared signal; and
a hybrid apparatus, including a first switch unit and a detection unit, having a virtual-wall mode and a lighthouse mode; the first switch unit being to switch the hybrid apparatus to one of the virtual-wall mode and the lighthouse mode; the detection unit including a first detection mode, a second detection mode and a third detection mode; the hybrid apparatus selectively being on one of the first detection mode, the second detection mode and the third detection mode; when the hybrid apparatus is on the first detection mode and receives the infrared signal, the hybrid apparatus being to emit first signals continuously; when the hybrid apparatus is on the second detection mode, the hybrid apparatus using a supersonic signal to detect a distance between the self-propelled apparatus and the hybrid apparatus, the hybrid apparatus being to emit the first signals continuously if the distance is smaller than a threshold value; when the hybrid apparatus is on the third detection mode, the hybrid apparatus being to emit the first signals continuously if the hybrid apparatus receives the infrared signal or the distance is smaller than the threshold value; when the hybrid apparatus is on the virtual-wall mode, a coverage region of the first signals being a block region, the self-propelled apparatus walking away the block region of the corresponding hybrid apparatus after the self-propelled apparatus receives the first signals; when the hybrid apparatus is on the lighthouse mode, the coverage region of the first signals being a lighthouse region, the self-propelled apparatus entering and then passing through the lighthouse region of the corresponding hybrid apparatus after the self-propelled apparatus receives the first signals.

2. The hybrid system of virtual walls and lighthouses for self-propelled apparatuses of claim 1, wherein, after the self-propelled apparatus enters and then passes through the lighthouse region of the corresponding hybrid apparatus, and till the self-propelled apparatus leaves the lighthouse region of the corresponding hybrid apparatus, the first switch unit switches the hybrid apparatus to the virtual-wall mode.

3. The hybrid system of virtual walls and lighthouses for self-propelled apparatuses of claim 1, further including a second switch unit; wherein, when the hybrid apparatus is on the lighthouse mode, the lighthouse mode has a preset reference time, a first time value and a second time value, the first time value being larger than the preset reference time, the preset reference time being larger than the second time value, the second switch unit being to switch the self-propelled apparatus in the lighthouse region of the hybrid apparatus to work for one of the preset reference time, the first reference time and the second time value.

4. The hybrid system of virtual walls and lighthouses for self-propelled apparatuses of claim 1, wherein the hybrid apparatus includes a light-adjusting unit for adjusting strength of the first signal.

5. The hybrid system of virtual walls and lighthouses for self-propelled apparatuses of claim 1, wherein the first signal is an infrared signal.

6. The hybrid system of virtual walls and lighthouses for self-propelled apparatuses of claim 1, wherein the self-propelled apparatus further includes a turning member located at the main body; wherein, when the receiving member of the self-propelled apparatus receives a block signal, the turning member has the main body to turn so as to walk away the block region of the hybrid apparatus.

7. The hybrid system of virtual walls and lighthouses for self-propelled apparatuses of claim 1, further including:
a recharging station, wherein, after the self-propelled apparatus leaves the lighthouse region of the hybrid apparatus, the self-propelled apparatus enters the recharging station, and then the self-propelled apparatus electrically couples the recharging station.
